(19) United States
(12) Patent Application Publication
(10) Pub. No.: US 2007/0199888 A1
(43) Pub. Date: Aug. 30, 2007

(54) Water filter device for beverage brew baskets

(76) Inventors: Elizabeth Japp, Boynton Beach, FL (US); Kenneth R. Parker, Delray Beach, FL (US); Venkat Yeeli, Delray Beach, FL (US); Courtney Groome, Fort Lauderdale, FL (US)

Correspondence Address: Lawrence J. Shurupoff;Sunbeam Products, Inc., 2381 Executive Center Drive, Boca Raton, FL, 33431, US

(21) Appl. No.: 11/365,753

(22) Filed: Feb. 28, 2006

(51) Int. Cl. B01D 35/00

(52) U.S. Cl. 210/474; 210/464; 210/473; 210/475

(57) ABSTRACT

A water filter device for use with a brew basket associated with a coffee maker or other brewed beverage device including a water filter member and a filter holder member adaptable for holding the water filter member. The filter holder member includes one or more support tabs extending outwardly from the periphery thereof to an extent effective for engaging the brew basket so as to support the filter holder member on the brew basket. The filter holder member further includes at least one guide channel positioned and located for removably receiving the water filter member therewithin. The water filter member may include a grip tab for allowing a user to easily grasp the water filter member for easy insertion and removal from the filter holder member.

### BACKGROUND OF THE INVENTION

The present invention relates to water filter devices for brew baskets such as those used in coffee makers and other brewed beverage devices and, more particularly, to substantially one-piece water filter holding member which allows for quick and easy removal and replacement of the filter member without the need of replacing the holding structure.

Various devices have been devised to provide water filters for coffee makers and other brewed beverage type devices, many of them being complicated and costly. For example, one of the more simple water filter devices includes a filter contained in a circular filter holder that is rimmed with a plurality of flexible thermoplastic supporting tabs. This device is pushed down into a generally conical brew basket until the supporting tabs resiliently bend against the interior surface of the brew basket. These flexible supporting tabs support the overall filter within the brew basket. See, for example, Koslow et al. U.S. Patent Publication No. US2001/0032822 A1. Unfortunately, this device is prone to movement within the brew basket due to the fact that the thermoplastic supporting tabs tend to soften and lose their resiliency when subjected to heat and stress. This means that the filter may drop onto the coffee grounds or other brewed substances, or the filter may tip allowing unfiltered water to reach the coffee grounds or other brewed substances.

Other known water filter constructions include a filter holder device having the filter member fixedly mounted thereon such as by adhesively bonding, insert molding, ultrasonically welding, or otherwise permanently attaching the filter member to the filter holder. In this particular arrangement, the filter member and filter holder must be replaced as a single unit. Other prior art constructions include a two-piece filter holder adaptable for mounting upon a brew basket using a plurality of support tabs, the filter holder including a carrier member having a plurality of support tabs associated therewith, and a top retainer member wherein the filter member again is bonded or otherwise fixed to the top retainer member. In this construction, the top retainer member and associated filter member must be replaced when a new filter member is desired.

Still further, another known prior art water filter device includes a three-piece unit wherein support tabs are associated with the filter holder, and the filter member is held in proper position adjacent the filter holder through the use of a retaining ring which attaches to the bottom of the filter holder such as by screwing onto the bottom of the filter holder or by using any other suitable interlocking means. In this construction, the filter is sandwiched and/or clamped between the filter holder and the retaining ring. Replacement of the filter member involves unscrewing or detaching the retaining ring from the bottom portion of the filter holder; removing the filter member from the retaining ring; placing a new filter member within the retaining ring; and thereafter again suitably attaching the retaining ring to the filter holder to sandwich the filter member therebetween. See, Applicant's co-pending U.S. patent application Ser. No. 10/833,530 for examples of the above-referenced prior art structures.

Since water filters lose their effectiveness after a period of use and therefore must be replaced, users want simple and inexpensive water filter devices. As indicated above, replacement of prior art water filter members can be expensive, time consuming and complicated; some require the purchase of an entirely new water filter device, or portions thereof other than simply the water filter member; and some water filter devices are simply inexpensive and ineffective. It is therefore desirable to provide a water filter device which is inexpensive, simple, effective, and which allows users to easily and inexpensively replace used water filter members when needed.

Accordingly, the present invention is directed to a water filter device which overcomes one or more of the problems set forth above.

### SUMMARY OF THE INVENTION

The present invention overcomes many of the shortcomings and limitations of the prior art devices discussed above and teaches the construction and operation of a water filter device adapted for use with a wide variety of different brew baskets used in association with coffee makers and other brewed beverage making devices. In one aspect of the present invention, the present water filter device includes a water filter holder member having both means for supporting the water filter holder upon a brew basket, and means for removably receiving a water filter member adjacent one end portion thereof.

More particularly, in one aspect of the present invention, the support means for suspending the filter holder member upon a particular brew basket may include one or more support tabs extending outwardly from the periphery of the filter holder member to an extent effective to engage the brew basket. The support tabs are of sufficient dimension and strength when supported on the brew basket so as to demonstrate no substantial deformation, under normal heat conditions, during use. A single support tab may extend a sufficient distance around the periphery or rim of the filter holder member so as to adequately suspend and support the entire device on or over the brew basket. The receiving means for holding the filter member adjacent one end portion of the filter holder member may include at least one guide channel associated with the filter holder member adaptable for slidably receiving the water filter member. In this regard, the filter member may include a frame structure and tab means for allowing a user to easily insert and remove the water filter member from the filter holder member.

In another aspect of the present invention, the filter member and filter holder member include corresponding means for properly positioning and locating the filter member within the channel receiving means.

In another aspect of the present invention, the filter member and the filter holder member may include cooperatively engageable means for temporarily securely holding the filter member within the channel receiving means during normal use.

In another aspect of the present invention, the filter member and the corresponding channel receiving means may include additional means for preventing rotation of the filter member within the channel receiving means.

In another aspect of the present invention, the filter holder member may include a date indicator.

### BRIEF DESCRIPTION OF THE DRAWINGS

For a better understanding of the present invention, reference may be made to the accompanying drawings.

FIG. 1 is perspective view of one embodiment of the present water filter device constructed in accordance with the teachings of the present invention.

FIG. 2 is perspective view of one embodiment of the present filter holder member without the water filter member inserted therein, illustrating the construction of the top portion thereof.

FIG. 3 is another perspective view of the filter holder member of FIG. 2 illustrating the construction of the bottom portion thereof.

FIG. 4 is a side perspective view of the filter member of FIG. 2 with the water filter member inserted into the filter holder member.

FIG. 5 is a perspective view of one embodiment of the water filter member of FIGS. 1 and 4.

### DETAILED DESCRIPTION OF THE INVENTION

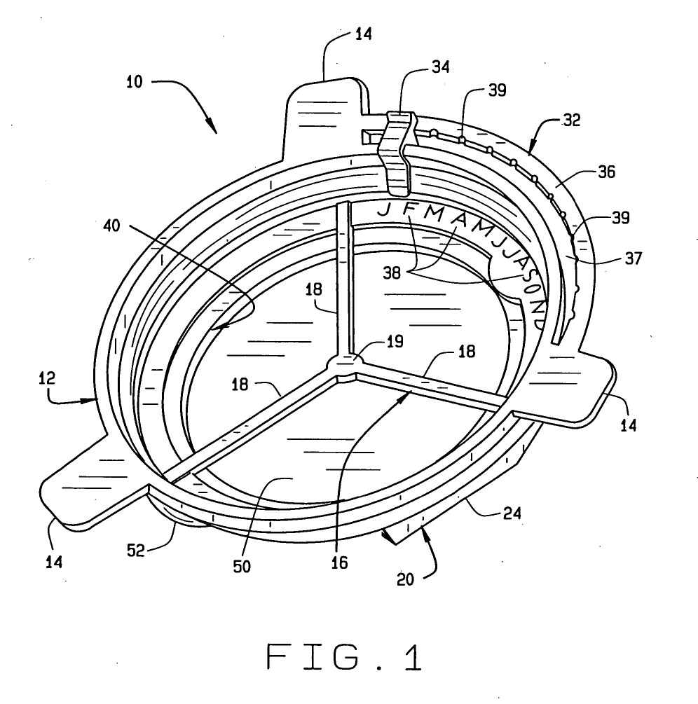

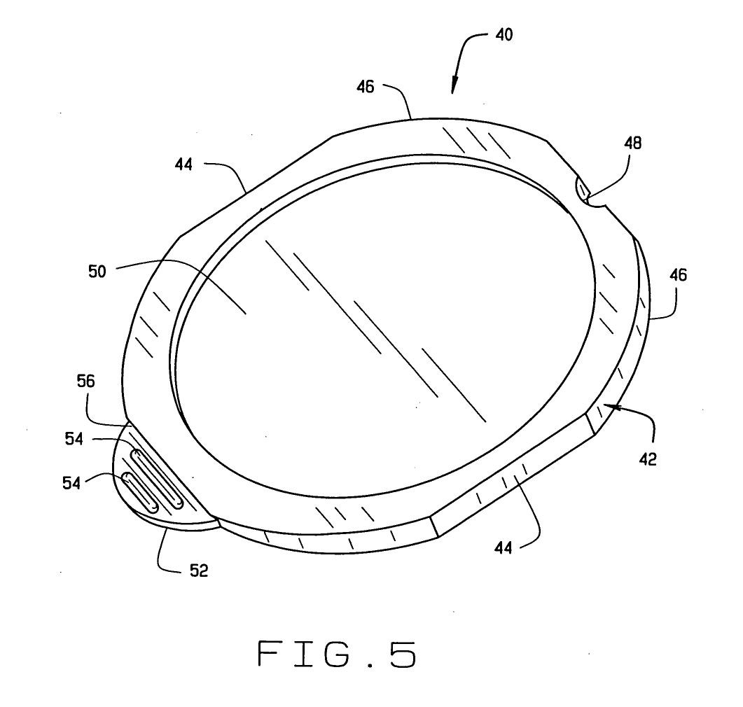

Referring to the drawings more particularly by reference numbers wherein like numerals refer to like parts, the number 10 in FIGS. 1 and 5 identifies one embodiment of a water filter device constructed according to the teachings of the present invention. The device 10 includes a water filter holder member 12 and a water filter member 40, and is generally annularly shaped so as to conform with the shape of most brew baskets associated with coffee makers and other similar type brewed beverage making devices. The filter holder member 12 includes a plurality of support tabs 14 that extend outwardly therefrom to engage the top surface of top rim of a typical brew basket (not shown). The support tabs 14 rest upon an upper surface of the walls or other structure of a brew basket and support the filter holder member 12 upon the brew basket so as not to interfere with the insertion and removal of the brew basket into and out of a coffee maker or other beverage making device. As will be hereinafter explained, the filter holder member 12 is specifically designed to removably hold and support the water filter member 40.

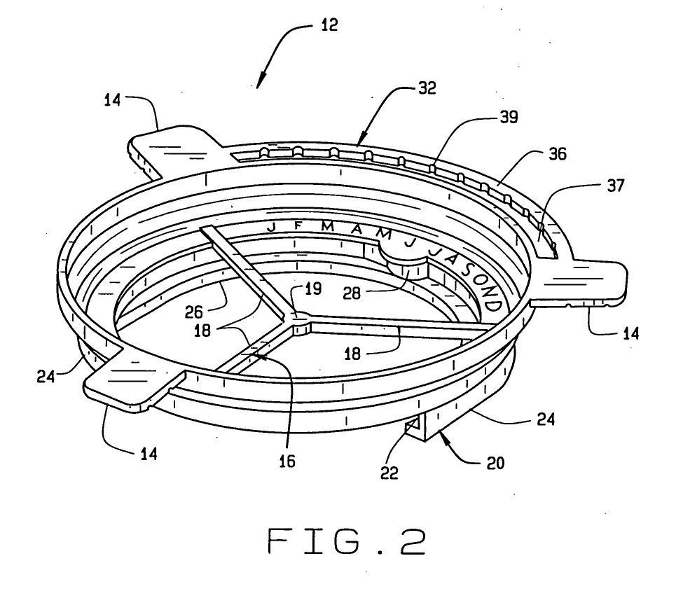

As best illustrated in FIGS. 1 and 2, the filter holder member 12 is shown as having three support tabs 14 since this number provides sufficient support and stability to hold the filter holder member 12 securely in place upon the brew basket while minimizing the amount of material needed to fabricate the member 12. However, it is recognized and anticipated that any plurality of support tabs 14 could be utilized and still be within the scope of the present invention. In addition, it is also recognized and anticipated that one support tab could likewise be utilized in association with the present invention if the single support tab is formed as an annular ring or rim encircling the rim or periphery of the filter holder member 12, and if the single support member extends around a substantial portion of the periphery of the holder member 12 such as extending more than 180° around the periphery thereof. Although one support member may be used as explained, this requires substantially more material as compared to the support tab structure 14 illustrated in FIGS. 1 and 2. Preferably, the support tabs 14 are integrally formed or homogeneously molded onto the filter holder member 12, and such support tabs extend outwardly as illustrated only far enough to adequately support the filter holder member 12 upon a typical brew basket, but not so far as to interfere with the insertion and removal of the brew basket from the coffee maker or other beverage making device.

It is also recognized and anticipated that the filter holder member 12 may be supported above a particular brew basket through other means including other support structures such as snap-on mounting tabs. Still further, the present filter holder member 12 may be supported by a hinge mechanism which links the filter holder member 12 with a particular brew basket. In this particular arrangement, the filter holder member may be removably and replaceably snap-fitted to the brew basket such as through the use of a pair of resilient ball and socket hinges of the type commonly used on hinged plastic boxes and the like. A piano type hinge may also be used. A user may simply swing open the filter holder member away from the brew basket via the hinge mechanism. In the open position, a user can access the contents of the brew basket, for example, to add or remove ground coffee beans, and a user may likewise easily access and removably replace the water filter member 40 as will be hereinafter further explained. See Applicant's co-pending U.S. patent application Ser. No. 10/833,530 for further disclosure with respect to snap-on mounting tabs and various types of hinges for hingedly attaching the filter holder member to a brew basket.

As best illustrated in FIGS. 1-4, the filter holder member 12 preferably includes the support structure 16 which extends inwardly from the periphery of the holder member 12. The support structure 16, as illustrated, includes a plurality of cross braces 18 extending inwardly from three points on the periphery of the filter holder member 12, all cross brace members 18 meeting at a central point 19. It is recognized and anticipated that although the support structure 16 illustrated in FIGS. 1-4 provides adequate support for the filter holder member 12 while minimizing the amount of material needed to form such structure, other support structures are likewise adequate and available for use. One skilled in the art could easily devise other support structure orientations and formations to provide the necessary support and stability to the holder member 12. For example, a “cross” formation or an “X” formation would likewise suffice. However, the support structure 16 should not take up so much space within the interior of the filter holder member 12 as to hinder or otherwise obstruct the passage of water therethrough, as water must pass through the open space formed by the support structure 16 to reach the filter member 40. Although the support structure 16 provides mechanical support and stability to the overall filter holder member 12, one skilled in the art could likewise devise a filter holder member construction without the need for incorporating the support structure 16 therein, for example, by constructing the filter holder member out of a highly structurally sound material such as a strong composite material, a metal alloy, or other similar materials.

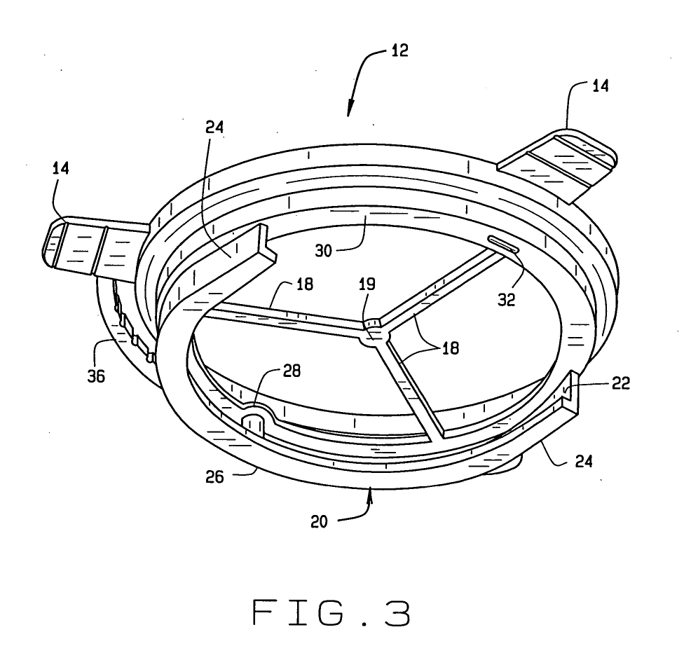

As best illustrated in FIGS. 2 and 3, the filter holder member 12 likewise includes a guide channel 20 which is preferably integrally formed with the holder member 12 and is shaped so as to conform to the overall shape of the filter member 40 illustrated in FIG. 5. In the embodiment illustrated in FIGS. 1-4, the guide channel 20 is formed adjacent the bottom portion 30 of the filter holder member 12 and extends downwardly therefrom forming a groove or slot 22 which extends the entire length of the guide channel 20. The groove or slot 22 is sized and shaped so as to receive the frame member 42 associated with filter member 40 (FIG. 5). In this regard, in the embodiment illustrated in FIGS. 1-4, the guide channel 20 includes substantially straight side portions 24 which correspond to the substantially straight side portions 44 associated with the filter frame member 42. The remaining portion 26 of the guide channel 20 which extends between the substantially straight side portions 24 is angularly shaped and corresponds to the angularly shaped portions 46 of the filter frame member 42. The guide channel 20 is specifically sized and shaped so that the filter frame member 42 can be slid into and out of the guide channel 20.

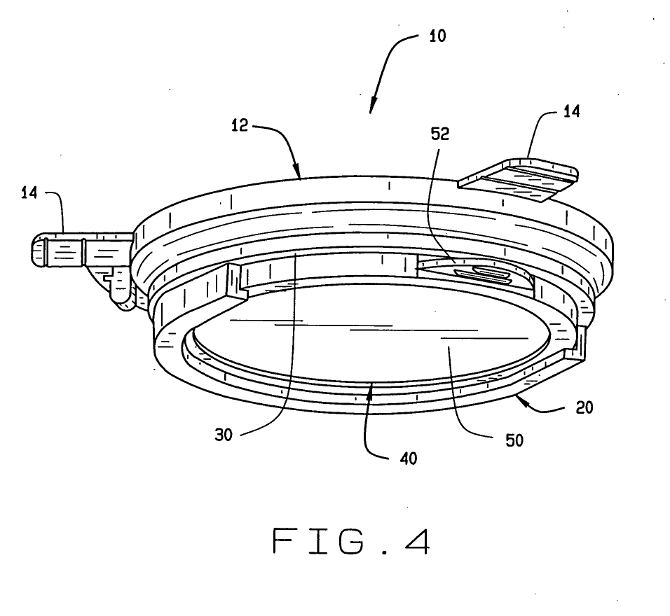

Engagement of the filter member 40 with the guide channel 20 of the filter holder member 12 is illustrated in FIG. 4. The filter member 40 can be easily slidably maneuvered into and out of the guide channel 20 thereby making replacement of the filter member 40 an easy task. The filter member 40 should fit snugly within the guide channel 20, but should not fit so tightly that it is difficult for a user to insert and remove the filter member 40 when necessary. The substantially straight side portions 44 of the filter frame member 42 prevent rotation of the water filter member 40 when engaged with the guide channel 20. However, it is recognized and anticipated that the filter frame member 42 and associated water filter 50 could take on a wide variety of different shapes such as circular, oval, square, rectangular, and other polygonal shapes, and that the guide channel 20 can be correspondingly positioned and shaped so as to receive the frame member associated with the water filter member 40. It is also recognized and anticipated that the filter frame member 42 and the corresponding guide channel 20 of filter holder member 12 can be selected and configured to enable only correspondingly conformingly shaped water filter members 40 to be used with certain coffee makers, brew baskets, or other brewed beverage making devices.

As best illustrated in FIGS. 1-4, the rear portion of the guide channel 20 preferably includes a protrusion 28 extending inwardly from the guide channel 20. The protrusion 28 is sized and shaped so as to correspond to an indentation or recessed portion 48 associated with the filter frame member 42 as best illustrated in FIG. 5. The interaction between the protrusion 28 of the filter holder member 12 and the recessed portion or indentation 48 of the water filter member 40 serves as locating means or a keying mechanism for properly positioning the water filter member 40 within the guide channel 20 and likewise serves to further prevent rotation of the filter member 40 within the guide channel 20. The protrusion 28 and the corresponding recessed portion 48 are optional features and merely further facilitate proper orientation of the water filter member 40 when slidably engaged with the guide channel 20. Other locating means or keying systems could likewise be utilized if so desired to facilitate proper positioning of the filter member 40 within the guide channel 20.

Although FIGS. 1-4 illustrate the use of a single guide channel 20 extending annularly around a portion of the bottom surface 30 of the filter holder member 12, other formations and shapes of guide channels are within the spirit and scope of the present invention. For example, two guide channels on opposite sides of the filter holder member 12 may suffice for engaging the water filter member 40. In fact, any plurality of spaced guide channels positioned and located around the periphery of the filter holder member 12 may be utilized so long as they are positioned and located to slidably receive the filter frame member 42. The shape, configuration, and size of the guide channels are not important so long as the guide channels are shaped and sized so as to cooperatively receive the correspondingly shaped water filter member 40. The only limitation is that a user should be able to insert and remove the water filter member 40 from the corresponding guide channels without significant force or resistance. Although guide channel 20 is illustrated as being positioned and located adjacent one end portion of the filter holder member 12, it is recognized and anticipated that the guide channel(s) can be located anywhere within the filter holder member 12 so long as once the water filter member 40 is positioned therewithin, the filter member 40 is positioned in communication with the brew basket such that water flowing through the filter member will enter the brew basket.

FIG. 5 illustrates one embodiment of the water filter member 40 which includes a filter element 50 completely encased or housed in operative position within the frame member 42. The frame member 42 extends around the circumferential edge of the filter 50 to provide additional support and rigidity to the filter 50. The filter 50 may be adhesively bonded, insert molded, ultrasonically welded or otherwise permanently attached or removably attached such as by a snap fit to the filter frame member 42. In this manner, the water filter 50 and its associated frame member 42 comprise a single unit which may be easily replaced when necessary. The preferred water filter 50 is a filtering agent, such as an activated carbon, sandwiched between two porous sheets of material. A preferred water filter member 40 is thin, perhaps no more than a sixteenth to an eighth of an inch in thickness. The filter 50 and its associated frame member 42 provide a means to remove impurities from the water for brewed beverages. If the water filter member 40 is too thick, water will filter through the filter 50 too slowly thereby causing water to overrun around the sides of the frame member 42.

As illustrated in FIG. 5, the filter member 40 likewise preferably includes a grip tab 52 extending outwardly from the front portion of the water filter member 40 so that a user may easily grasp the filter member 40 when inserting or removing the member from the water filter holder 12. Use of the grip tab 52 helps to prevent a user from touching the filter media 50 when inserting and removing the filter member 40. The grip tab 52 is molded or otherwise attached to the filter frame member 42 such that a lip or edge 56 is formed adjacent thereto as illustrated in FIG. 5. The lip or edge 56 functions as part of a holding mechanism for holding the filter member 40 within the guide channel 20 as will be hereinafter explained. The grip tab 52 may also include one or more rib members 54 positioned and located on at least one side portion thereof for facilitating the gripping or grasping of the filter member 40 by a user.

As best illustrated in FIG. 3, the bottom surface 30 of the water filter holder member 12 includes a protruding or projecting rib 32 extending downwardly therefrom, the projecting rib 32 being positioned and located so as to cooperatively engage the lip or edge 56 associated with the joinder of the grip tab 52 to filter frame member 42. In this regard, with the lip or edge 56 positioned towards the rib 32, as the water filter member 40 is slidably positioned within the guide channel 20, the projecting rib 32 will interact with and engage the edge 56 thereby temporarily preventing the water filter unit 40 from exiting the guide channel 20 without the use of force. In other words, the water filter member 40 will not exit the guide channel 20 during normal use. However, when a user wants to remove the filter member 40 from the filter holder member 12, the user merely pulls the grip tab 52 so that the projecting rib 32 is pulled over the lip or edge 56 thereby allowing the filter member 40 to slide out of the guide channel 20. The interaction of the member 32 with edge 56 thereby functions as an over center mechanism for holding the water filter member 40 in proper position within the guide channel 20.

It is also recognized and anticipated that other cooperatively engageable means associated with the filter holder member 12 and the water filter member 40 could likewise be utilized for temporarily securing the water filter member 40 within the guide channel 20. For example, the projecting rib 32 associated with the filter holder member 12 could merely cooperatively engage a portion of the frame member 42 of the filter member 40, or the projecting rib 32 could engage a protrusion or projection associated with the upper portion of the filter frame member 42. Still further, the projecting rib 32 could likewise engage a portion of the grip tab 52, or the rib 32 could engage any one of the rib members 54 associated with the grip tab 52. In other words, the grip tab 52 and/or the filter frame member 42 could be configured so as to interact with the projecting rib 32 associated with the filter holder member 12 in a wide variety of different ways and applications. It is also recognized and anticipated that the projecting rib 32 could be replaced with equivalent structure or some other cooperatively engageable means for interacting with any portion of the filter frame member 42, any portion of the filter grip tab 52, or any other edge portion or projection associated respectively therewith. This cooperatively engageable means need only temporarily hold and/or secure the water filter member 40 within the guide channel 20 of the filter holder member 12 so as to prevent the filter member 40 from sliding out of engagement with the guide channel 20 during normal use. Other structures and locking mechanism can likewise be used to accomplish this task.

As best illustrated in FIGS. 1 and 2, the water filter holding member 12 may include a date indicator 32, including a slide indicator 34, a notched arcuate member 36 extending between two spaced apart support tabs 14, a slide groove 37, and date graduations 38 positioned opposite the notches 39. The date graduations 38 will preferably indicate the twelve months of the year, although other date reference means may be utilized. When the user replaces the filter member 40, a user slides the slide indicator 34 to the proper notch 39 opposite the appropriate month or other date reference so as to indicate either the current month or the month that the filter member 40 should be replaced. In this manner, the user is reminded when to change the filter member 40. The slide indicator 34 is adapted to resiliently snap into and out of the notches 39. This date indicator mechanism is further disclosed in Applicant's co-pending U.S. patent application Ser. No. 10/833,530.

Although it is recognized and anticipated that the various components of the present water filter device 10 can be fabricated from a wide variety of suitable materials, it is preferred that the water filter holder member 12 and the filter frame member 42 be constructed of a thermoplastic material. In this regard, homopolymers, such as polyethylene and polypropylene, are inexpensive and readily available thermoplastics. Polypropylene is preferred over polyethylene because of its greater resistance to deformation under conditions of heat and stress.

Because the water filter member 40 can be easily slidably removed and replaced within the guide channel 20 of filter holder member 12, there is no need for a user to open and close the filter device to change the filter element 50. A user need only purchase a new water filter member 40 when it is necessary to replace the existing filter member, and merely slide out the old filter member and slide in the new filter member. The water filter holder member 12 need not be discarded and can be repeatedly used with a plurality of new water filter members 40. As a result, replacement of the water filter member 40 is simple and inexpensive, and it does not require the purchase of the entire water filter device. Replacement water filter members such as the member 40 are readily available and use of the guide channel 20 facilitates quick and easy replacement.

Thus, there has been shown and described several embodiments of a novel water filter device which is adaptable for use with a wide variety of different types of brew baskets associated with coffee makers and other brewed beverage devices, which water filter device fulfills all of the objectives and advantages sought therefore. Many changes, modifications, variations and other uses and applications of the present invention will, however, become apparent to those skilled in the art after considering this specification and the accompanying drawings. All such drawings, modifications, variations and other uses and applications which do not depart from the spirit and scope of the present invention are deemed to be covered by the present invention which is limited by the claims which follow.

1. A water filter device for use with a brew basket comprising:
a water filter member; and
a filter holder member adaptable for holding said water filter member, said filter holder member having at least one support tab extending outwardly from the periphery thereof to an extent effective for engaging a brew basket so as to support said filter holder member on the brew basket;
said filter holder member further including at least one guide channel for removably receiving said water filter member therewithin.

2. The water filter device defined in claim 1 wherein said water filter member includes a grip tab positioned and located to facilitate grasping of the water filter member by a user.

3. The water filter device defined in claim 1 wherein said water filter member includes an indentation, and wherein said filter holder member includes a corresponding projection adaptable for mating with said indentation when said water filter member is received within said at least one guide channel.

4. The water filter device defined in claim 1 wherein said at least one guide channel includes at least one side portion which is substantially straight.

5. The water filter device defined in claim 1 wherein said filter holder member includes one guide channel extending around at least one half of the periphery thereof.

6. The water filter device defined in claim 5 wherein said one guide channel includes substantially straight opposed side portions.

7. The water filter device defined in claim 6 wherein said water filter member includes substantially straight opposed side portions which correspond to the substantially straight opposed side portions associated with said one guide channel.

8. The water filter device defined in claim 1 wherein said filter holder member includes at least one projecting rib which extends downwardly therefrom, said at least one projecting rib interacting with said water filter member when said water filter member is received within said at least one guide channel for temporarily securing said water filter member within said at least one guide channel.

9. The water filter device defined in claim 8 wherein said water filter member includes an edge portion, said edge portion engaging said projecting rib for temporarily securing said water filter member within said at least one guide channel.

10. The water filter device defined in claim 1 wherein said filter holder member includes a date indicator.

11. A water filter device for use with a brew basket comprising:
a water filter member; and
a filter holder member having at least one support tab extending outwardly therefrom to an extent effective for engaging a brew basket so as to suspend said filter holder member thereupon;
said filter holder member further including at least one guide channel positioned adjacent one end portion thereof for removably receiving said water filter member therewithin.

12. The water filter device defined in claim 11 wherein said at least one guide channel is sized and shaped so as to correspond to the size and shape of said water filter member.

13. The water filter device defined in claim 11 wherein said water filter member includes a frame member, said frame member being correspondingly shaped so as to be slidably removably received within said at least one guide channel.

14. The water filter device defined in claim 13 wherein said frame member includes a grip tab positioned and located to facilitate grasping of the water filter member by a user.

15. The water filter device defined in claim 13 wherein said frame member includes an indentation, and wherein said filter holder member includes a corresponding projection adaptable for mating with said indentation when said water filter member is received within said at least one guide channel.

16. The water filter device defined in claim 11 wherein said at least one guide channel has at least one portion thereof which is substantially straight.

17. The water filter device defined in claim 11 wherein said filter holder member includes at least one projecting rib, and said water filter member includes means cooperatively engageable with said at least one projecting rib for temporarily securing said water filter member within said at least one guide channel when said water filter member is received therewithin.

18. The water filter device defined in claim 17 wherein said water filter member includes a frame member, and wherein said means cooperatively engageable with said at least one projecting rib includes said frame member.

19. The water filter device defined in claim 17 wherein said water filter member includes a grip tab, and wherein said means cooperatively engage able with said at least one projecting rib includes said grip tab.

20. The water filter device defined in claim 17 wherein said water filter member includes a frame member and a grip tab extending therefrom, and wherein said means cooperatively engageable with said at least one projecting rib includes an edge portion formed at the joinder of said grip tab with said frame member.

21. The water filter device defined in claim 11 wherein said filter holder member includes a date indicator.

22. The water filter device defined in claim 11 wherein said filter holder member includes support structure extending inwardly from the periphery thereof.

23. The water filter device defined in claim 18 wherein said frame member includes at least one projecting rib, said at least projecting rib associated with said filter holder member interacting with said at least one projecting rib associated with said frame member for temporarily securing said water filter member within said at least one guide channel when said water filter member is received therewithin.

24. The water filter device defined in claim 19 wherein said grip tab includes at least one projecting rib, said at least one projecting rib associated with said filter holder member interacting with said at least one projecting rib associated with said grip tab for temporarily securing said water filter member within said at least one guide channel when said water filter member is received therewithin.

25. The water filter device defined in claim 11 wherein said filter holder member includes a plurality of support tabs.

26. A water filter device for use with a brew basket comprising:
a water filter member having a frame member and a filter element extending therebetween; and
a filter holder member adaptable for holding said water filter member, said filter holder member having a plurality of support tabs extending outwardly therefrom for engaging a brew basket, said plurality of support tabs enabling said filter holder member to be positioned and located in supporting relationship to a brew basket such that said water filter member is positioned in communication therewith;
said filter holder member further including a guide channel positioned and located adjacent one end portion of said filter holder member for insertably removably receiving said water filter member therewithin.

27. The water filter device defined in claim 26 wherein the frame member associated with said water filter member includes a grip tab extending outwardly therefrom.

28. The water filter device defined in claim 27 including cooperatively engageable means associated with said filter holder member and said water filter member for temporarily securing said water filter member within said guide channel when said water filter member is insertably positioned therewithin.

29. The water filter device defined in claim 28 wherein said cooperatively engageable means includes at least one projecting rib associated with said filter holder member and an edge portion formed at the joinder of said grip tab with said frame member, said at least one projecting rib engaging said edge portion when said water filter member is insertably positioned within said guide channel.

30. The water filter device defined in claim 28 wherein said cooperatively engageable means includes at least one projecting rib associated with said filter holder member and at least one projecting rib associated with said grip tab, said at least one projecting ribs interacting with each other when said water filter member is insertably positioned within said guide channel.

31. The water filter device defined in claim 26 wherein said filter frame member includes substantially straight opposed side portions and said guide channel includes substantially straight corresponding opposed side portions.

32. The water filter device defined in claim 26 wherein the frame member associated with said water filter member includes an indentation, and wherein said filter holder member includes a corresponding projection adaptable for mating with said indentation when said water filter member is insertably positioned within said guide channel.
